(19) United States
(12) Patent Application Publication
(10) Pub. No.: US 2004/0161609 A1
(43) Pub. Date: Aug. 19, 2004

(54) Cubic boron nitride/diamond composite layers

(76) Inventors: Igor Bello, Hong Kong (HK); Wen Jun Zhang, Hong Kong (HK); Shuit-Tong Lee, Hong Kong (HK)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/366,880

(22) Filed: Feb. 14, 2003

(51) Int. Cl. B32B 9/00

(52) U.S. Cl. 428/408; 428/698

(57) ABSTRACT

Cubic boron nitride/diamond (cBND) composite films with excellent adherence to various substrates and their fabrication method are disclosed. The cBND composite confining cBN can be prepared without any amorphous/turbostratic BN (aBN/tBN) incubation layers. The cBND composite is established on the compatibility of structural and physical properties of two superior materials: cBN on top and diamond beneath. The underlying diamond is adapted to the substrate of choice using a variety of methods which may include prescratching the substrates, bias enhanced nucleation, etching for depleting undesirable chemical elements, construction of buffer layers and gradient buffer layers for the isolation of undesirable chemical elements or/and adaptation of physical properties. The diamond nuclei are preferably formed either by bias-enhanced nucleation or by pre-scratching the substrate prior to nucleation. The cBN films in cBND composites of the present invention can grow directly on the underlaying diamond films in heteroepitaxial relationships.

### FIELD OF THE INVENTION

The present invention relates to the formation of cubic boron nitride/diamond (cBND) composite layer structures useful for depositing cubic boron nitride on a variety of substrates such as metals, alloys and semiconductor materials with the provision of high film adherence to the substrate. Such cBND structures may then be used in electronic and mechanical applications including protective, tribological coatings, and coating of machine tools.

### BACKROUND OF THE INVENTION

Boron nitride (BN), by analogy to carbon, can appear in a cubic crystalline structure (cBN) similar to diamond and a hexagonal crystalline form (hBN) like that of graphite. BN can also exist in lonsdaleite-like wurtzitic (wBN), rhombohedral (rBN) and turbostratic (tBN) phases. Among these allotropes sp³-bonded cBN in zinc-blend structure is the most attractive crystalline form. The strong covalent bonds and high atom density make cBN a unique material with properties comparable to those of diamond. cBN has the widest band gap (>6 eV) among all the covalent-bonded materials, the second highest hardness next to diamond, extraordinary chemical inertness, high electrical resistivity, high carrier mobility, and extremely high thermal conductivity.

The unusual combination of its physical and chemical properties makes cBN a potentially very useful material for the fabrication of cutting tools, thermal, optical, and high-temperature and high-frequency electronic devices. Although cBN has a little lower hardness and smaller thermal conductivity than diamond, it is superior to diamond in mechanical applications due to its chemical inertness to ferrous materials up to temperatures of 1500-1600 K. Therefore, cBN is a very good material for machining ferrous materials and their composites.

Furthermore, cBN can be doped for either p-type or n-type conductivities while n-type doping of diamond is still problematic. Hence, cBN is also a better candidate for fabricating high-speed, high-power electronic devices operating at high temperature [O. Mishima, J. Tanaka, S. Yamaoka, and O. Fukunaga, Science vol. 238, pps.181-183, “High-temperature cubic boron nitride p-n junction diode made at high pressure”, 1987].

The study of the synthesis and characterization of cBN and diamond started almost simultaneously in the early 1960s [R. H. Wentorf, Jr., J. Chem. Phys. Vol. 36. pps. 1990-1991, “Preparation of semiconducting cubic boron nitride”, 1962]. To date, cBN has been commercially synthesized in large quantities as powders with sizes ranging from submicron to millimeters by a high-pressure high-temperature (HPHT) method [N. V. Novikov, Diamond Relat. Mater., vol. 8, pps. 1427-1432, “New trends in high-pressure synthesis of diamond”, 1999]. Together with HPHT diamond, HPHT cBN has a large market especially in cutting tools and wear parts.

The severe nature of the HPHT methods and the limited size of cBN grains produced, however, rule out some of its attractive potential applications. Research in chemical vapor deposition (CVD) of diamond films has progressed well and CVD diamond has been implemented in some industrial areas such as protective coats, cutting inserts, heat sinks, optical windows, etc. Methods have been developed for growing diamond films at reduced temperatures and pressures. However, diamond films are not well-suited for cutting or abrading ferrous materials. Diamond reacts with iron forming soots at the high temperatures generated during cutting operations.

Accordingly, it would be desirable to provide a method for the implementation of cBN films on tools. However, because cBN films grow via soft amorphous and turbostratic boron nitride (aBN and tBN) and exhibit high stress, they suffer from poor adhesion.

Cubic boron nitride films can be deposited by both physical vapor deposition (PVD) and CVD methods. For PVD methods, bombardment of substrates by energetic species (tens to hundreds of eV) is known to be important to the formation of the cBN phase [T. Yoshida, Diamond Relat. Mat., vol. 5, pps.501-507, “Vapour phase deposition of cubic boron nitride”, 1996; P. B. Mirkarimi, K. F. McCarty, and D. L. Medlin, Mater. Sci. Eng., vol. R21, pps.47-100, “Review of advances in cubic boron nitride film synthesis”, 1997]. Since ion bombardment is associated with a considerable internal stress that restricts the maximal thickness of adherent, non-delaminating cBN films to ˜200 nm, this presents a further obstacle to its practical application.

For CVD, by using boron trifluoride as the boron source, thick cBN films may be deposited by DC jet plasma CVD and microwave plasma CVD. It is known that fluorine can selectively etch non-cubic BN. The substrate bias needed for the formation of cBN phase is dramatically reduced using CVD and correspondingly the residual stress in the films was reduced. However, the cBN films deposited by this method still grow via the layered structure of amorphous and textured hexagonal (turbostratic, tBN) phases [W. J. Zhang, S. Matsumoto, K. Kurashima, and Y. Bando, Diamond Relat. Mater., vol. 10, pps.1881-1885, “Structure analysis of cBN films prepared by DC jet plasma CVD from an Ar—N₂—BF₃—H₂ gas system”, 2001], serving as incubation layers for cBN nucleation. However, the existence of the amorphous/turbostratic interface causes random orientation of the cBN film, and diminishes the film adhesion in humid environments. Therefore, adherent cBN films to a substrate without aBN/tBN transition layers, non-sensitive to humidity and even grown in an epitaxial relationship to the substrate are highly desired to meet practical applications.

### SUMMARY OF THE INVENTION

According to the present invention there is provided a composite structure comprising a substrate, an intermediate diamond layer, and a layer of cubic boron nitride. Preferably the composite structure may further comprise a buffer layer between the substrate and the intermediate diamond layer.

According to another aspect of the present invention there is provided a method of fabricating a composite structure comprising a substrate, an intermediate diamond layer, and a layer of cubic boron nitride, comprising the steps of: forming diamond nuclei on a substrate, growing a layer of diamond film on the substrate, and depositing a top layer of cubic boron nitride on the diamond layer to form a composite structure of cubic boron nitride/diamond film on the substrate.

Preferably the substrate may be pre-treated prior to formation of the diamond layer. This pretreatment may comprise, for example, pre-scratching to enhance nucleation and subsequent adhesion of the diamond layer, or pre-treatment to remove undesirable chemical components from the substrate (eg any component that may act catalytically to convert the diamond to graphite phase).

The diamond film may be formed by chemical vapour deposition, while the cBN layer may be formed by chemical vapour deposition or physical vapour deposition.

### BRIEF DESCRIPTION OF THE DRAWINGS

Some embodiments of the invention will now be described by way of example and with reference to the following Figures, in which:

FIG. 1 is a schematic view of an apparatus for the use in carrying out a method according to an embodiment of this invention;

FIG. 2 is a scanning electron microscopic image of a substrate formed with a diamond film in an intermediate stage of an embodiment of the present invention;

FIG. 3 is scanning electron microscopic surface morphology of a cBND composite with a top cBN film formed in accordance with an embodiment of the invention;

FIG. 4 is a scanning electron microscopic cross-sectional morphology of the cBND composite film of FIG. 3;

FIG. 5 illustrates the Fourier-transformed infrared spectrum obtained from the cBND composite film of FIG. 3;

FIG. 6 illustrates the Raman spectrum obtained from the cBND composite film of FIG. 3;

FIG. 7 is a cross-sectional transmission electron microscopy (TEM) image taken from the cBND composite film; and

FIG. 8 is a cross-sectional high-resolution TEM image taken from the interfacial region between the cBN and diamond films.

### DETAILED DESCRIPTION OF THE PREFERRED EMBODIMENTS

As will be seen from the following description, at least in its preferred forms the present invention provides environmentally/humidity non-sensitive and highly adherent cBN/diamond (cBND) composite coatings on a variety of substrates and their production technology. The cBND coatings consist of top layer of cBN and a diamond layer underneath. The diamond layer underneath is deposited prior to the cBN film and provides structural compatibility, high adhesion, extreme supporting capacity for any mechanical applications and enables heteroepitaxial growth of cBN films.

The diamond layer underneath can be grown via buffer layers such as pretreated nitrides or specially pretreated materials, for example, prescratching and chemical etching of some substrate components to eliminate their catalytic effect inducing graphitic phase. Growing such adherent cBND layers on various substrates opens many industrial applications.

The present cBND composite films and preferred methods of their production involve a multiple-step procedure. First of all the substrates are pretreated using prescratching, chemical etching methods or a combination thereof depending on the substrates used. Alternatively, the pretreated substrates can be coated by a buffer layer, for example, with nitride or carbide layers or their combinations and gradient layers. The buffer layers can further be prescratched. All these pretreatments and precoatings can be combined prior to the deposition of the cBND composite. Thus, the cBND compatibility and adherence to the substrate is aided by the pretreatment procedure and/or gradient buffer layers, which in the case of some substrates can be more complex.

Subsequently, a continuous diamond film is formed, for example, by CVD methods. The diamond film thickness may vary upon the cBND applications. Finally the last component of cBND, cubic boron nitride is deposited onto the diamond interlayer using CVD or PVD methods.

The first component of the cBND composite, the diamond film, is prepared in a two sub-step process, i.e., nucleation and growth. The diamond nuclei are preferably formed either by bias-enhanced nucleation or by pre-scratching the substrate prior to nucleation. During nucleation a higher concentration of carbon precursors is normally used. The second component of cBND composite, cBN film can be grown directly on diamond films in a single growth process using particle energies close to the thermal energies. Neither amorphous nor tBN transition layers are needed for the formation of cBN films, and the cBN films show epitaxial relationship with the underlying diamond films.

Since the cBN and diamond are compatible in terms of their structures and physical properties there are no problems in adhesion as far as the adhesion cBND via diamond-substrate or diamond-substrate-buffer layer is provided. The absence of a hydroscopic aBN/tBN interface makes the cBND composite non-sensitive to humidity. In addition, diamond underneath with the highest hardness of all known materials provides cBN the best supporting capacity in all mechanical applications. Thus, the cBND coating composites are superior in ultrahard cutting tools for machining ferrous materials and their compounds at high speed and high temperatures, which are not otherwise possible by diamond-coated cutting tools. The isoelectronic properties of diamond and cBN, and epitaxial growth confined in cBND composites, allow use of these materials in electronics.

The deposition of the first component of a cBND composite, a diamond layer, is preceded by diamond nucleation on a pretreated or/and precoated substrate which has the capacity to accommodate cBND composite with excellent adhesion. Firstly diamond is nucleated using either bias-enhanced nucleation [X. Jiang, C. P. Klages, Diamond Relat. Mater., vol. 2, pps. 1112-1113, “Heteroepitaxial diamond growth on (100) silicon”, 1993] on a non-diamond substrate or enhanced nucleation employing scratching non-diamond substrate by hard powders of different composition and size such as diamond, SiC, Al₂O₃ or cBN. Secondly randomly oriented or highly oriented diamond films are grown by CVD methods via controlling alpha parameters, i.e., the concentration of carbon precursors in a hydrogen-based deposition environment and elevated substrate temperatures. In the case of heteroepitaxial growth of cBN films on diamond, highly oriented films are preferred in this intermediate step. Thirdly the cBN films are deposited by either CVD or PVD methods. More details of this process and the resulting cBND structures are described below.

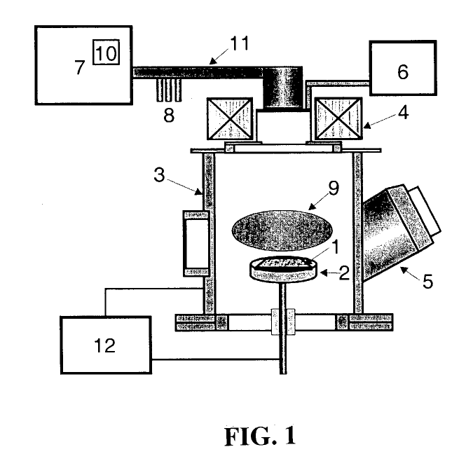

FIG. 1 shows a schematic diagram of a microwave plasma apparatus employed for fabricating cBND composite films in accordance with an embodiment of this invention. The apparatus includes sample 1, sample holder 2, reaction chamber 3, magnetic coil 4, turbomolecular pump 5, gas supply units 6, 2.45 GHz microwave generator 7, impedance transformer 8, powermeter 10, 11—waveguide 11, and biasing power supply 12. Reference numeral 9 indicates a plasma ball. When a magnetic field of ˜875 G is applied to the central region of the reaction chamber using an external magnetic coil 4 under low pressure conditions, an electron cyclotron resonance (ECR) mode of the system operation can be employed in the fabrication method of cBND films.

In preferred embodiments of this invention, a number of the parameters of the fabrication process, such as the choice of substrate, pretreatment, precoating, nucleation technique, the method of forming the diamond film, and the method of forming the cBN film, can be varied depending upon the particular substrate and intended use of cBND composite films.

In the preparation of the diamond film, which serves as the base material for the manufacture of cBND composite films, CVD environments including either cold or thermal plasmas excited by direct current, alternating current, radio-frequency, microwave or other electromagnetic radiations are possible. Flame methods can be applied as well. Similarly, the top cBN layer can be prepared by CVD methods using either cold (non-equilibrium) or thermal (equilibrium) plasma driven by direct, alternating current, high-frequency current, and microwaves or other electromagnetic radiations. Depending on the excitation method used, power can be supplied into the plasma via internal electrodes, capacitive and inductive coupling, antenna coupling, resonator coupling, surface-wave excitation or other known methods. As seen, in the case of diamond film deposition demonstrated as an example below, cold plasma was induced by microwaves, which were fed into a reactor via an impedance transformer. The same system was used for depositing the cBN top layer. However, the system operated in an electron cyclotron resonance (ECR) mode and used a different reactive environment in term of composition, total pressure and control parameters including substrate bias and temperature.

The top cBN layer of cBND composite can also be prepared by a variety of ion assisted physical vapor deposition (PVD) methods including magnetron sputtering, ion assisted deposition, biased plasma deposition and ion beam deposition. [T. Yoshida, Diamond Relat. Mat., vol. 5, pps.501-507, “Vapour phase deposition of cubic boron nitride”, 1996; P. B. Mirkarimi, K. F. McCarty, and D. L. Medlin, Mater. Sci. Eng., vol. R21, pps.47-100, “Review of advances in cubic boron nitride film synthesis”, 1997]. The bombardment by energetic species (tens to hundreds of eV) coupled with the exposure to boron and nitrogen species (examples of the different exposure routes are: sputtering of a BN target, sputtering or evaporation of boron, boron containing gas, nitrogen or nitrogen containing gas) can be employed for the formation and the cBN phase growth. However, the cBN formation within the cBND composite promotes lower particle kinetic energies, which range expands from very high energies down close to the thermal energies of particles.

The deposition environment of the base diamond film is established predominantly on plasma-activated carbon precursor (e.g., methane, carbon oxide)-hydrogen gas mixture. The optimum flow rates of such reactant gases may vary considerably depending on the plasma type, method of plasma generation, gas pressure, geometrical configuration of a reactor and other processing parameters.

With respect to the gas used in the synthesis of cBN films for the construction of cBND composite layers by CVD, at least one compound selected from the groups of boron hydrides (e.g., diborane and decaborane), boron halides (e.g., boron trichloride and boron triflouride), borohydrides (e.g., sodium borohydride), borofluoride (e.g., ammonium borofluoride or trimethylboride—TMB), or organic boron compounds such as triethoxyboron may be used as a boron source. On the other hand, at least one member selected from the group consisting of nitrogen gas, hydrides of nitrogen such as ammonia and hydrazine, fluorides of nitrogen such as nitrogen trifluoride and nitrogen tetrafluoride, etc. may be used as a nitrogen source. The boron gas and nitrogen gas sources react to precipitate boron nitride. In the example below, the gases are selected so that fluorine is surely present in the gas phase to take advantage of the fact that fluorine can selectively etch non-cubic BN. Fluorine can also be added into a gas mixture using fluorine gas, hydrogen fluoride, halogen fluoride such as chlorine trifluoride or bromine trifluoride, or a halide of an inert gas such as xenon fluoride, or fluorine obtained by decomposition of an organic fluorine compound such as tetrafluoromethane, a fluorine compound such as sulfur hexafluoride, sulfur tetrafluoride, silicon tetrafluoride, phosphorous pentafluoride or a metal fluoride can be supplied into the gas phase, in addition to the compounds above.

Further, an inert gas such as argon or helium, or a hydrogen gas can be optionally added to the gas phase for controlling the plasma stability, plasma density, deposition rate and film properties. Instead of using separate chemical species of nitrogen and boron, a single chemical species such as amine borane, borazine, aminoborane or dimethylaminoborane can be added to the gas phase. The optimum flow rates of such material gases vary significantly depending on the plasma type, the method for generating the plasma, the geometrical configuration and size of deposition apparatus, pressure, substrate bias voltage and the like.

The fabrication method of the intermediate diamond films may use a gas phase pressure of the order from 10⁻⁴ to 10² Torr. In the example to be described below, working in microwave plasma CVD system and ECR operation mode, a pressure from 20 to 100 Torr is recommended for providing a high reaction rate and ease of control of the deposition. For the deposition of the top cBN films in cBND composite layers, working in an ECR mode at a pressure of 10⁻³ Torr is recommended. Such implemented conditions provide the high density of reactive radicals, high ion-to-neutral ratio and thus high reaction rate, and simple control of the deposition.

In embodiments of the present invention, the deposition of cBND composite layer can be prepared on a variety of non-diamond substrates including semiconductors (e.g., silicon or silicon carbide and nitride), insulators (e.g., quartz and sapphire), metals such (e.g., platinum and iridium), and alloys (e.g., tungsten carbide), which can, however, be pretreated as described above.

The formation of the diamond layer in cBND composite films can be prepared by both PVD and CVD methods at temperatures widely ranging from room temperature to 1400° C. In terms of the deposition by ECR MW CVD, the practical range is from 600 to 1300° C.

The surface morphology and the orientation of the intermediate diamond film in cBND composite are controlled via the growth parameters [C. WILD, et al., Diamond Relat. Mater., vol. 3, pps. 373-381, “Oriented CVD diamond films—Twin Formation, Structure and Morphology”, 1994]. The growth rate in both the [001] and [111] growth directions is controlled by changing the concentration of carbon precursor in the CVD environment, substrate temperature and other parameters. The [001]-oriented diamond films are preferable in terms of the epitaxial deposition of cBN films for electronic applications.

The fabrication method of the top cBN layer in the cBND composite can employ direct current and/or high frequency or radio-frequency bias with negative offset. The practical value of negative bias ranges from −10 V to −1500 V which is along with the plasma potential responsible for the energy and momentum of incident ions. Therefore, it varies with many parameters including the method of generating plasma, gas composition, gas pressure and substrate materials.

The parameters leading to the nucleation and growth of cBN by ion assisted PVD methods include: (1) a minimum ion energy necessary to promote nucleation, (2) a minimum substrate temperature, (3) a proper balance between the energetic species and the thermal species (I/A ratio), (4) a proper balance of the species involved (B, N, and foreign species) allowing to establish an equilibrium between the incorporation on one hand and the sputtering/etching/desorption rates on the other hand.

Depending on the application fields desired, the phase purity (cBN content) of cBN film can be controlled by varying the gas composition in the plasma, substrate bias voltage, substrate temperature and other deposition parameters.

The following examples are presented for a further understanding of the cBND composite and method of cBND preparation by means of embodiments of the present invention.

### EXAMPLE 1

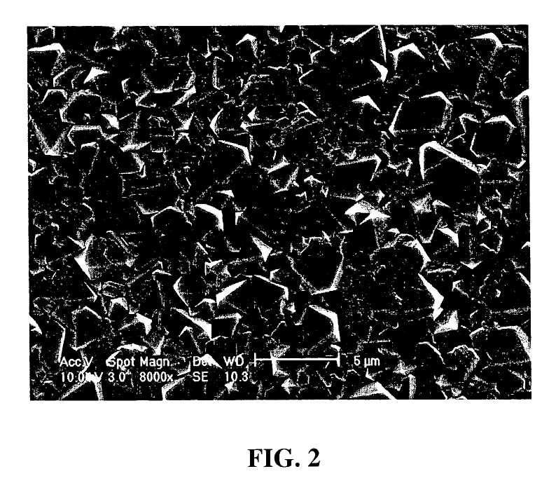

A diamond film, an SEM plain-view image of which is shown in FIG. 2, with a thickness of about 5 μm was prepared by microwave plasma CVD with controlled growth parameters such as the concentration of carbon precursor and temperature using the CVD apparatus shown in FIG. 1.

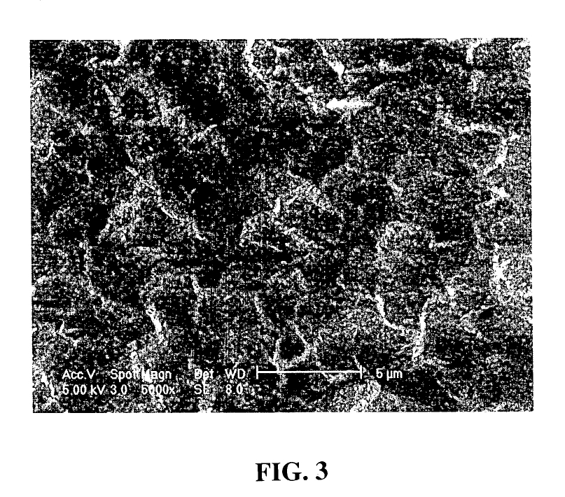

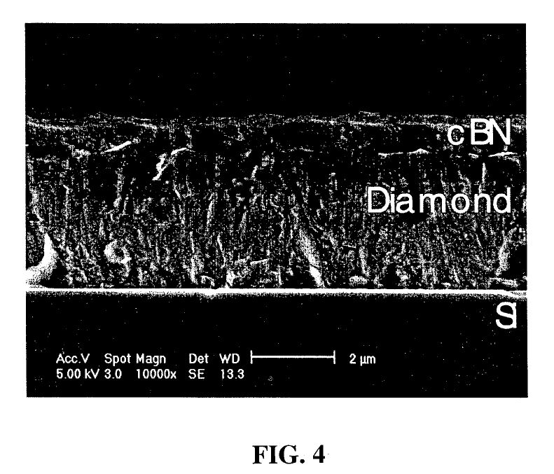

The cBN film was subsequently deposited in the same apparatus, but prior to the deposition the reactor chamber was evacuated to 10⁻⁶ Torr by a turbo-molecular pump 5 and then BF₃, N₂, He, Ar, and H₂ at gas flow rates of 1, 50, 140, 10 and 3 sccm, respectively, were supplied into the chamber from a gas supply unit 6 to secure the operation pressure of 2×10⁻³ Torr. Using such conditions and a magnetic field of ˜875 gauss applied to the central region of the reaction chamber employing an external magnetic coil 4, the deposition was carried out in an electron cyclotron resonance (ECR) mode. The 1500 W microwave power at 2.45 GHz was supplied by a microwave generator 7 and fed via a waveguide 11. The reflected microwave power was adjusted to its minimum value, close to zero, using the impedance transformer 9. Both the forward and reflected microwave powers were constant and monitored over the entire deposition. In this particular case, direct current bias of −30 V, provided by a dc power supply 11, was applied to the substrate with respect to the grounded chamber. The cBN film was deposited at a substrate temperature of 950° C. for 2 hours in order to obtain a continuous film as demonstrated by scanning electron microscopic (SEM) images in FIGS. 3 and 4. FIGS. 3 and 4 are SEM plain-view with a top cBN layer and cross-sectional images of the cBND composite film deposited by this process, respectively. The cBND composite with a continuous top cBN film of about 700 nm thickness is clearly demonstrated.

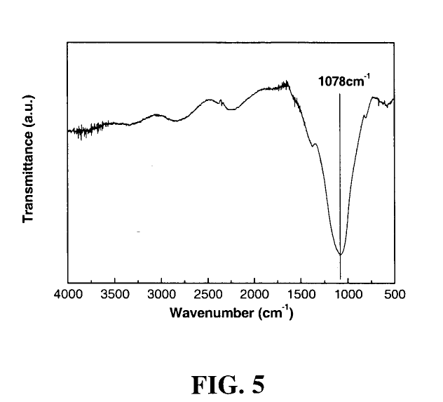

FIG. 5 is a Fourier-transformed infrared absorption spectrum collected from the sample of FIGS. 3 and 4. The infrared absorption of cubic boron nitride significantly appears in the vicinity of 1070 cm⁻¹. The absorption peaks at 780 and 1360 cm⁻¹ indicate a diminutive content of hexagonal/turbostratic/amorphous boron nitride in the film. From the spectrum, the content of such non-cubic phase is less than 10%.

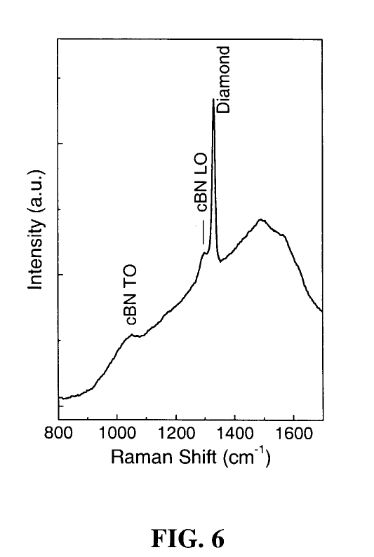

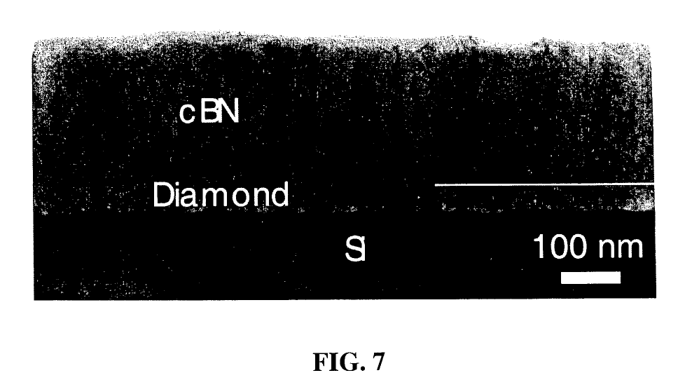

FIG. 6 is a graph illustrating a Raman spectrum collected from the cBND composite film, shown in FIGS. 3 and 4, using backscattering geometry and an argon ion laser with an excitation line at 514.5 nm. The characteristic diamond scattering mode present at 1331 cm⁻¹ indicates the existence of diamond intermediate layer in cBND composite. Scattering peaks of cubic boron nitride by phonon of an optical longitudinal wave mode at 1300 cm⁻¹ and by phonon of an optical transverse wave mode at 1050 cm⁻¹ also distinctly appears, showing the composite nature of the cBND structure. Transmission electron microscopic (TEM) analysis, in FIG. 7, indicates a columnar structure of the cBND composite film. Both cBN and diamond form continuous columns extended from silicon substrate via diamond-cBN interface to the top surface of cBND composite.

The detailed TEM analyses show that cBN directly nucleates on diamond, and forms continuous columns extending from diamond to its surface. No incubation layer (aBN/tBN) for the nucleation of cBN in cBND structure is observed, which can also be proved by the absence of tBN diffraction pattern.

### EXAMPLE 2

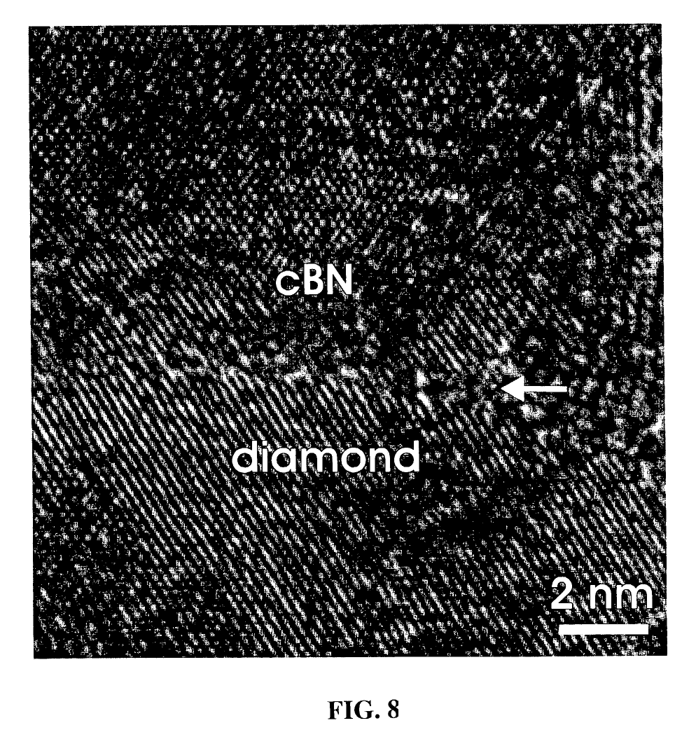

In a cBND composite with [001]-oriented diamond films serving as base/intermediate layer, heteroepitaxial growth of cBN films on diamond may be obtained. The cBN deposition was performed in the same deposition system as described above in EXAMPLE 1. The epitaxial orientation relationship between cBN and underlying diamond is demonstrated by the high-resolution TEM image as shown in FIG. 8.

Cubic boron nitride incorporated in cBND composite has the second highest hardness and second highest thermal conductivity next to diamond, however, unlike diamond it is chemically inert to ferrous materials and their compounds at high temperature. Accordingly, the cBND composite films without any aBN/tBN incubation layer required for cBN nucleation by the present invention is practical for coating cutting tools. The extraordinary properties of cBND composite comes from the cBN-diamond compatibility in terms of their structures and physical properties, ease of cBND accommodation on a variety of substrates with high adhesion and the excellent supporting capacity of diamond in any mechanical applications. Further, the epitaxial growth of cBN on diamond is the fundamental provision for preparing p- and n-type semiconductors, and p-n junction devices such as diodes or transistors which may be potentially exploited in power electronics and optoelectronics operating in harsh environment.

At least in its preferred forms therefore, the present invention provides cBN/diamond (cBND) composite films and methods of their fabrication via multiple steps. The substrate may preferably be pretreated or/and pre-coated to accommodate cBND composite films with high adherence. The pretreatment can be in a single or multiple step process. A pretreatment such as prescratching provides high nucleation density and enhances adhesion. On the other hand chemical etching depletes undesirable chemical elements in close surface regions. Under undesirable chemical elements are understood such elements which have a catalytic effect on the conversion of diamond to graphite phase. These elements can also be isolated by diffusion buffer and gradient buffer layers. The buffer layers also diminish the differences in physical properties of the cBND composite and substrate. The gradient buffer layer can be established on hard nitride compounds. All these methods can be combined in accordance with the substrate used.

The difficulties associated with using cBN coatings in the prior art have been substantially mitigated by synthesizing cBN in the form of cBND composite films on the surfaces of materials of interest and via buffer layers if required. Such composites with top cBN layers are endowed with excellent adherence, chemical inertness, extremely high hardness, low friction coefficient and very high supporting capacity for the top cBN layer provided by the diamond. All these superior properties enable applications of cBND composites in protective, tribological and other mechanical applications. In addition, the wide bandgap and isoelectronic properties to diamond with capacity for n- and p-type doping make it suitable for some special electronic applications.

All the references cited herein are hereby expressly incorporated by reference into the present application.

What is claimed is:

1. A composite structure comprising a substrate, an intermediate diamond layer, and a layer of cubic boron nitride.

2. A composite structure as claimed in claim 1 further comprising a buffer layer between said substrate and said intermediate diamond layer.

3. A composite structure as claimed in claim 1 comprising epitaxial diamond and cubic boron nitride layers.

4. A method of fabricating a composite structure comprising a substrate, an intermediate diamond layer, and a layer of cubic boron nitride, comprising the steps of:
(a) forming diamond nuclei on a substrate,
(b) growing a layer of diamond film on said substrate, and
(c) depositing a top layer of cubic boron nitride on said diamond layer to form a composite structure of cubic boron nitride/diamond film on said substrate.

5. A method as claimed in claim 4 wherein said substrate is pretreated prior to step (a) to enhance adhesion of the diamond film to the substrate.

6. A method as claimed in claim 4 wherein a buffer layer is provided between said diamond film and said substrate.

7. A method as claimed in claim 4 wherein said substrate is pre-scratched prior to step(a).

8. A method as claimed in claim 4 wherein said step (a) comprises bias-enhanced nucleation on said substrate.

9. A method as claimed in claim 4 wherein said substrate is selected from the group consisting of silicon, silicon carbide, quartz, sapphire, platinum and iridium, tungsten carbide.

10. A method as claimed in claim 4 wherein the substrate is a semiconductor material.

11. A method as claimed in claim 4 wherein said step (b) comprises a chemical vapor deposition process.

12. A method as claimed in claim 4 wherein said step (b) comprises growing said diamond layer with random or (001) orientation.

13. A method as claimed in claim 4 wherein said step (b) comprises controlling the alpha parameter during growth.

14. A method as claimed in claim 4 wherein said step (b) further comprises doping said layer of diamond film.

15. A method as claimed in claim 4 wherein said step (c) comprises cubic boron nitride deposition by either CVD or PVD methods.

16. A method as claimed in claim 15 wherein the boron-containing gas is selected from the group consisting of: boron hydrides, boron halides, borohydrides, borofluorides or organic boron compounds.

17. A method as claimed in claim 15 wherein the nitrogen-containing gas is at least one member selected from the group consisting of: nitrogen gas, nitrogen hydrides, nitrogen fluorides.

18. A method as claimed in claim 11 wherein a negative-bias is applied to the substrate during said deposition process.

19. A method as claimed in claim 11 further comprising adding inert gas and hydrogen into the plasma.

20. A method as claimed in claim 15 further comprising controlling the phase purity of the cubic boron nitride film by varying deposition parameters selected from the group consisting of the gas composition in the plasma, substrate bias voltage, and substrate temperature.

21. A method as claimed in claim 15 wherein a negative-bias is applied to the substrate during said deposition process.

22. A method as claimed in claim 15 further comprising adding inert gas and hydrogen into the plasma.
